(19) United States
(12) Patent Application Publication
(10) Pub. No.: US 2024/0278721 A1
(43) Pub. Date: Aug. 22, 2024

(54) VEHICLE OUTER MIRROR

(71) Applicant: TOYOTA JIDOSHA KABUSHIKI KAISHA, Toyota-shi (JP)

(72) Inventor: Hiroshige IMAIZUMI, Chita-gun, Aichi-ken (JP)

(21) Appl. No.: 18/389,792

(22) Filed: Dec. 20, 2023

(30) Foreign Application Priority Data
Feb. 17, 2023 (JP) 2023-023807

(51) Int. Cl. B60R 1/06; B60R 1/12

(52) U.S. Cl. CPC B60R 1/06; B60R 1/1207

(57) ABSTRACT

A vehicle outer mirror includes: an outer lens that includes a protruding portion, the protruding portion protruding out toward a vehicle width direction outer side, at a vehicle rear side than a cover that covers a vehicle width direction outer side of a light source; and a light guiding lens that includes a main body portion, a rear portion of the main body portion being disposed further along an inner face of the outer lens at the vehicle rear side than the protruding portion, and an intermediate portion of the main body portion being separated from an inner face of the protruding portion toward a vehicle width direction inner side, and that includes an outer-side extending portion that is integral with and branches from the rear portion of the main body portion and that is disposed along the inner face of the protruding portion, the light guiding lens guiding light from the light source.

### CROSS-REFERENCE TO RELATED APPLICATION

This application is based on and claims priority under 35 USC 119 from Japanese Patent Application No. 2023-023807, filed on Feb. 17, 2023, the entire disclosure of which is incorporated by reference herein.

### BACKGROUND

### Technical Field

The present disclosure relates to a vehicle outer mirror with a side turn lamp.

### Related Art

As disclosed in, for example, Japanese Patent Application Laid-Open (JP-A) No. 2017-114173, door mirrors as in vehicle outer mirrors in which a side turn lamp is incorporated are conventionally known.

Incidentally, in order to improve the design properties of a door mirror, there are cases in which part of an outer lens of a side turn lamp may protrude out further toward a vehicle width direction outer side further than a cover for concealing a light source of the side turn lamp.

However, when part of the outer lens protrudes out further toward the vehicle width direction outer side than the cover, a gap is generated between that part of the outer lens and a light guiding lens that guides light from the light source, and when the door mirror is viewed from the outside during non-lighting, the rear side of that part of the outer lens appears dark, thereby spoiling the appearance of the door mirror.

### SUMMARY

The present disclosure provides a vehicle outer mirror that is capable of improving design properties and suppressing spoiling of appearance.

A vehicle outer mirror according to a first aspect of the present disclosure includes: an outer lens that includes a protruding portion, the protruding portion protruding out further toward a vehicle width direction outer side, at a vehicle rear side than a cover that covers a vehicle width direction outer side of a light source; and a light guiding lens that includes a main body portion, a rear portion of the main body portion being disposed further along an inner face of the outer lens at the vehicle rear side than the protruding portion, and an intermediate portion of the main body portion being separated from an inner face of the protruding portion toward a vehicle width direction inner side, and that includes an outer-side extending portion that is integral with and branches from the rear portion of the main body portion and that is disposed along the inner face of the protruding portion, the light guiding lens guiding light from the light source.

In the first aspect, the outer lens includes a protruding portion that protrudes out further toward the vehicle width direction outer side, at the vehicle rear side than the cover that covers the vehicle width direction outer side of the light source. Therefore, the design properties of the vehicle outer mirror are improved. Further, the light guiding lens that guides light from the light source includes a main body portion, a rear portion of the main body portion being disposed further along an inner face of the outer lens at the vehicle rear side than the protruding portion, and an intermediate portion of the main body portion being separated from the inner face of the protruding portion toward a vehicle width direction inner side, and includes an outer-side extending portion that is integral with and branches from the rear portion of the main body portion and that is disposed along the inner face of the protruding portion. Therefore, when the vehicle outer mirror is viewed from the outside during non-lighting, the rear side of the protruding portion of the outer lens does not appear dark, and spoiling of the appearance of the vehicle outer mirror is suppressed.

A vehicle outer mirror according to a second aspect of the present disclosure is the vehicle outer mirror according to the first aspect, wherein a pattern is formed at an outer face of the outer-side extending portion.

In the second aspect, a pattern is formed at the outer face of the outer-side extending portion of the light guiding lens. This improves the appearance through the outer lens when the vehicle outer mirror is viewed from the outside during non-lighting.

A vehicle outer mirror according to a third aspect of the present disclosure is the vehicle outer mirror according to the first aspect or the second aspect, and further includes a connecting portion that is integral with and connects a front end portion of the outer-side extending portion with the main body portion.

In the third aspect, the connecting portion is integral with and connects the front end portion of the outer-side extending portion with the main body portion. This enables the rigidity of the light guiding lens to be improved compared to a case in which the front end portion of the outer-side extending portion with the main body portion are not integral with and connected together by a connecting portion.

A vehicle outer mirror according to a fourth aspect of the present disclosure includes: an outer lens that includes a protruding portion, the protruding portion protruding out further toward a vehicle width direction outer side, at a vehicle rear side than a cover that covers a vehicle width direction outer side of a light source; and a light guiding lens that is made of resin, that is disposed along an inner face of the outer lens, and that guides light from the light source, wherein the light guiding lens includes a hollow portion that is formed at a vehicle width direction inner side of the protruding portion, and that has a substantially right-angled triangle shape in plan view.

In the fourth aspect, the outer lens includes a protruding portion, the protruding portion protruding out further toward the vehicle width direction outer side, at the vehicle rear side than the cover that covers the vehicle width direction outer side of the light source. Therefore, the design properties of the vehicle outer mirror are improved. Further, the light guiding lens, which is made of resin and guides light from the light source, is disposed along the inner face of the outer lens. Therefore, when the vehicle outer mirror is viewed from the outside during non-lighting, the rear side of the protruding portion of the outer lens does not appear dark, and spoiling of the appearance of the vehicle outer mirror is suppressed. Further, the light guiding lens includes a hollow portion that is formed at the vehicle width direction inner side of the protruding portion, and that has a substantially right-angled triangle shape in plan view. This enables the amount of the resin material that is used for molding the light guiding lens to be reduced, and enables the cooling time (manufacturing time) during molding to be reduced, compared to a case in which the light guiding lens does not include such a hollow portion.

A vehicle outer mirror according to a fifth aspect of the present disclosure is the vehicle outer mirror according to the fourth aspect, wherein a pattern is formed at an outer face of the light guiding lens which faces the inner face of the outer lens.

In the fifth aspect, a pattern is formed at the outer face of the light guiding lens which faces the inner face of the outer lens. This improves the appearance through the outer lens when the vehicle outer mirror is viewed from the outside during non-lighting.

As described above, the vehicle outer mirror according to the present disclosure enables design properties to be improved and spoiling of the appearance to be suppressed.

### BRIEF DESCRIPTION OF THE DRAWINGS

Exemplary embodiments of the present disclosure will be described in detail based on the following figures, wherein:

FIG. 1 is a schematic perspective view illustrating a door mirror according to an exemplary embodiment of the present disclosure;

FIG. 2 is a schematic cross-sectional view along the line X-X in FIG. 1;

FIG. 3 is a schematic cross-sectional view along the line Y-Y in FIG. 1;

FIG. 4 is a schematic cross-sectional view corresponding to FIG. 2, illustrating a modified example of the exemplary embodiment of the present disclosure;

FIG. 5 is a schematic cross-section in plan view illustrating a headlamp according to a reference example;

FIG. 6A is a schematic cross-sectional view corresponding to FIG. 2, illustrating a first comparative example;

FIG. 6B is a schematic cross-sectional view corresponding to FIG. 2, illustrating a second comparative example; and

FIG. 6C is a schematic cross-sectional view corresponding to FIG. 2, illustrating a third comparative example.

### DETAILED DESCRIPTION

Detailed explanation follows regarding an exemplary embodiment of the present disclosure, based on the drawings. Note that for convenience of explanation, in each of the drawings, as appropriate, the arrow UP is set in the vehicle upper direction, the arrow FR is set in the vehicle front direction, and the arrow RH is set in the vehicle right direction. Therefore, in the following explanation, in cases in which reference is made to up and down, front and rear, and left and right directions without specifically referring to the vehicle, this refers to the up and down direction, the front and rear direction, and the left and right direction with respect to the vehicle. Further, the left and right direction is the same as the vehicle width direction.

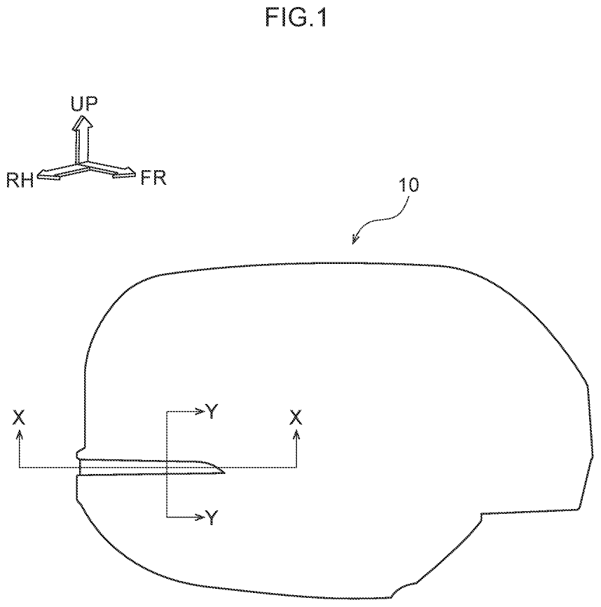

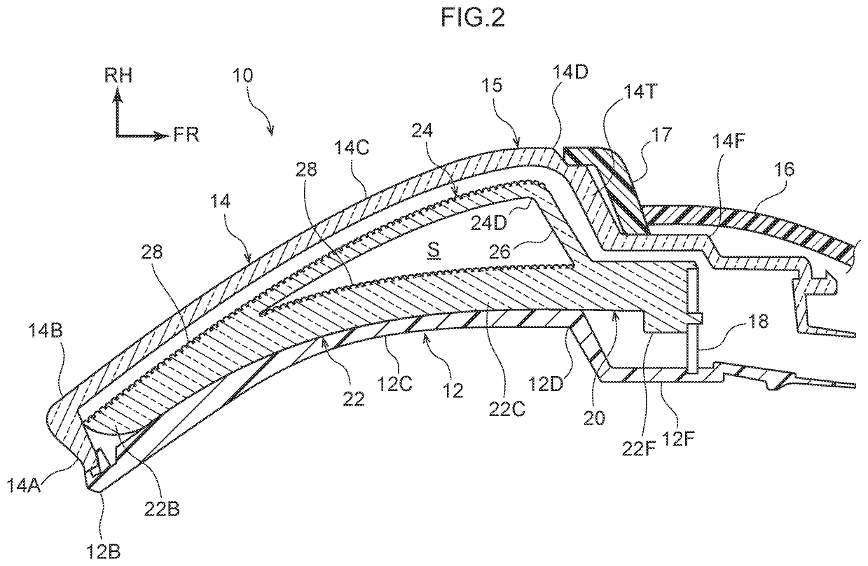

As illustrated in FIG. 1, a door mirror 10, serving as an example of a vehicle outer mirror, is provided at a side door (not illustrated) of a vehicle. The door mirror 10 is a door mirror, which includes a side turn lamp, provided at a right-side side door, and a light source 18 (see FIG. 2) or the like of the side turn lamp is incorporated at an outer side of a housing 12 that holds a mirror main body (not illustrated).

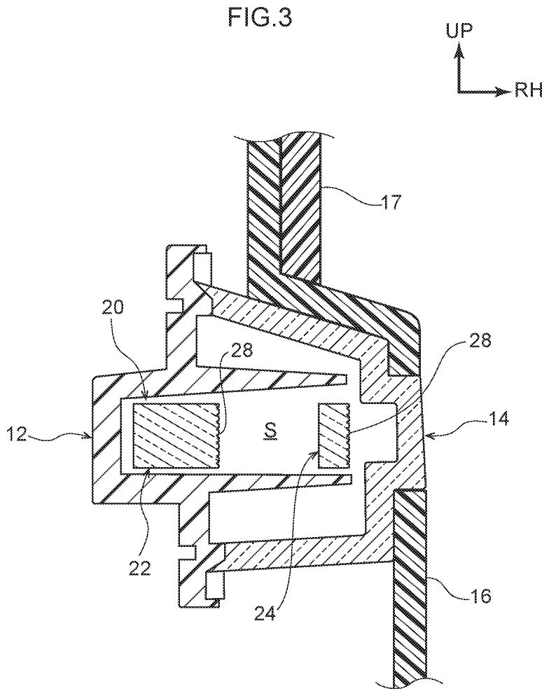

Specifically, as illustrated in FIG. 2 and FIG. 3, the door mirror 10 includes the housing 12 that is made of resin, and a mirror main body is housed at a vehicle width direction inner side of the housing 12. The housing 12 is formed into a substantially arc shape (a substantially curved shape), in plan view, that is convex toward a vehicle width direction outer side from a rear portion 12B of the housing 12 to an intermediate portion 12C of the housing 12, is bent toward a vehicle width direction inner side from a front end portion 12D of the intermediate portion 12C, and thereafter, is bent toward a front side to form a front portion 12F.

The light source 18 that irradiates light toward the rear is disposed at the front portion 12F. The light source 18 is configured from, for example, a light emitting diode (LED) substrate, and is configured such that power is supplied from a battery (not illustrated) and the LED emits light. Note that a light guiding lens 20 that is made of resin and that guides light irradiated from the light source 18 is disposed at a rear side of the light source 18. In other words, the light source 18 is disposed at a front end portion of the light guiding lens 20. Detailed explanation follows regarding the light guiding lens 20.

An outer lens 14 made of resin is provided at a vehicle width direction outer side of the light guiding lens 20. Arear end portion 14A of the outer lens 14 is bent into a substantially “L” shape in plan view and extends toward the vehicle width direction inner side, and a leading end (a vehicle width direction inner side end portion) of the rear end portion 14A of the outer lens 14 is joined and attached to a leading end (a rear end portion) of the rear portion 12B of the housing 12.

The outer lens 14 is formed into a substantially arc shape (a substantially curved shape), in plan view, that is convex toward the vehicle width direction outer side from a rear portion 14B of the outer lens 14 to an intermediate portion 14C of the outer lens 14, excluding the rear end portion 14A. Further, a step portion 14T that faces approximately a front-rear direction is formed at the outer lens 14 by the outer lens 14 being bent toward the vehicle width direction inner side from a front end portion 14D of the intermediate portion 14C, and a front portion 14F is formed by the outer lens 14 being bent toward the front side from a vehicle width direction inner side end portion of the step portion 14T. The light source 18 is disposed between the front portion 14F of the outer lens 14 and the front portion 12F of the housing 12.

A cover 16 made of resin, which conceals the light source 18 from the outside by covering a vehicle width direction outer side of the light source 18, is attached to an outer side of the front portion 14F of the outer lens 14. Further, a cover 17 that covers the step portion 14T from the front side is integrally provided at a rear side of the cover 16. Note that the step portion 14T and the intermediate portion 14C configure a protruding portion 15 that protrudes out further toward a vehicle width direction outer side of the outer lens 14. Namely, the protruding portion 15 that protrudes out a predetermined amount further toward the vehicle width direction outer side than the cover 16 is formed further toward the rear side than the light source 18, at the outer lens 14.

The light guiding lens 20 that guides light irradiated from the light source 18 and causes the entire outer lens 14 to uniformly light is provided at a vehicle width direction inner side of the outer lens 14, at the vehicle width direction outer side of the housing 12 (between the housing 12 and the outer lens 14). The light guiding lens 20 includes a main body portion 22, a rear portion 22B of the main body portion 22 being disposed further along an inner face of the outer lens 14 at the rear side than the protruding portion 15, and an intermediate portion 22C of the main body portion 22 being significantly separated from an inner face of the protruding portion 15 toward the vehicle width direction inner side, and includes an outer-side extending portion 24 that is integral with and branches (branches) from the rear portion 22B of the main body portion 22 and that is disposed along the inner face of the protruding portion 15.

Namely, the light guiding lens 20 faces (is in proximity to) the inner face of the outer lens 14 with a small gap in the substantially vehicle width direction from an outer face of the rear portion 22B of the main body portion 22 to an outer face of the outer-side extending portion 24, and the intermediate portion 22C of the main body portion 22 extends so as to be gradually separated from the protruding portion 15 as it moves toward the front side from the rear portion 22B of the main body portion 22. Note that the thickness of the outer-side extending portion 24 is formed thinner than the thickness of the main body portion 22.

A front portion 22F that is integral with and continuous from the intermediate portion 22C of the main body portion 22 extends between the front portion 12F of the housing 12 and the front portion 14F of the outer lens 14, and the light source 18 is attached and disposed at a front face of the front portion 22F. A connecting portion 26 is integral with and connects a front end portion 24D of the outer-side extending portion 24 and the intermediate portion 22C of the main body portion 22.

Note that the connecting portion 26 is configured to face (be in proximity to) the step portion 14T of the outer lens 14 with a small gap. Namely, the outer-side extending portion 24 and the connecting portion 26 are disposed along the inner face of the protruding portion 15 of the outer lens 14 (along an inner face of the intermediate portion 14C and the step portion 14T). Further, the thickness of the connecting portion 26 is also formed thinner than the thickness of the main body portion 22, and the connecting portion 26 illustrated in the drawings has substantially the same thickness as the outer-side extending portion 24.

The light guiding lens 20 is configured such that the main body portion 22, the outer-side extending portion 24, and the connecting portion 26 form a hollow portion S in a cut-out shape. Namely, the light guiding lens 20 is configured such that the hollow portion S in the form of a cut-out shape having a substantially right-angled triangle shape in plan view, with the right-angled portion positioned at the vehicle width direction outer side, is formed at a vehicle width direction inner side of the protruding portion 15 of the outer lens 14.

Len steps 28, serving as a pattern, are formed from the outer face of the rear portion 22B of the main body portion 22 to the outer face of the outer-side extending portion 24. The lens steps 28, serving as a pattern, are also formed at an outer face of the intermediate portion 22C facing the hollow portion S of the main body portion 22. As the lens steps 28, for example, an arbitrary pattern such as a polka-dot pattern that has a high texture (that appears three-dimensional) can be applied.

Explanation follows regarding operation of the door mirror 10 (vehicle outer mirror) according to the present exemplary embodiment configured as described above.

As illustrated in FIG. 1 to FIG. 3, the outer lens 14 of the door mirror 10 according to the present exemplary embodiment includes the protruding portion 15 that protrudes out further toward the vehicle width direction outer side, at the vehicle rear side than the cover 16 that covers the vehicle width direction outer side of the light source 18. This enables the design properties of the door mirror 10 to be improved. Further, the light guiding lens 20 of the door mirror 10 according to the present exemplary embodiment can suppress the appearance of the door mirror 10 from being spoiled, particularly when the light guiding lens 20 is not illuminated. Explanation follows.

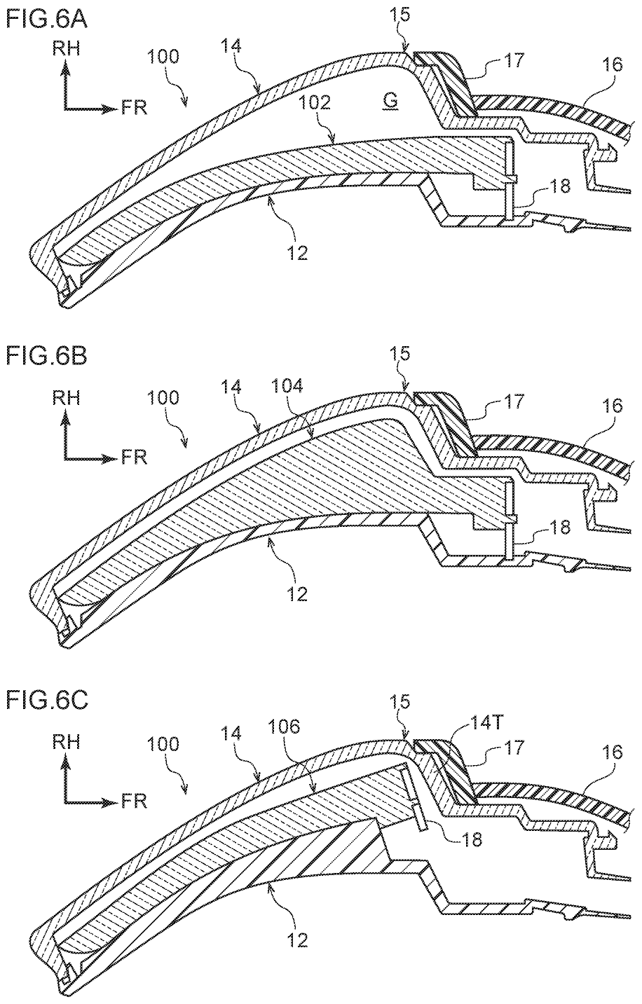

First, explanation follows regarding a door mirror 100 according to a comparative example. As illustrated in FIG. 6A, the outer-side extending portion 24 is not formed at a light guiding lens 102. In this case, due to there being a gap G between the protruding portion 15 of the outer lens 14 and the light guiding lens 102, when the door mirror 100 is viewed from the outside during non-lighting, the rear side of the protruding portion 15 of the outer lens 14 appears dark, and the appearance of the door mirror 100 is spoiled.

When lens steps (not illustrated in the drawings) serving as a pattern are formed at the inner face of the outer lens 14 so as to make the inside difficult to see, the appearance becomes one without a sense of depth, the appearance becomes one in which the lens steps are emphasized, and the appearance of the light guiding lens 102 that is to be viewed under normal circumstances is spoiled.

As illustrated in FIG. 6B, in a case of using a light guiding lens 104 having a thickness that is made thicker in the vehicle width direction so as to fill in the gap G, the amount of resin material that is used to mold the light guiding lens 104 increases, and the cooling time also increases, thereby increasing the manufacturing time. This increases manufacturing costs, mass, and the emission amount of carbon dioxide during manufacturing. Further, during lighting, a light guiding reflecting surface of the light guiding lens 104 changes, and the appearance of the door mirror 100 is spoiled.

In addition, as illustrated in FIG. 6C, in a case in which no gap G is formed as a light guiding lens 106 disposed along the inner face of the outer lens 14, since the light source 18 is attached to a front face of the light guiding lens 106, the light source 18 is disposed at a rear side of the step portion 14T. In this case, since light emitted from an LED, serving as the light source 18, is viewed directly from the outside, the appearance of the door mirror 100 is spoiled (merchantability decreases) due to glaring light when the light source 18 is turned on.

In contrast to these configurations, as illustrated in FIG. 2 and FIG. 3, the light guiding lens 20 of the door mirror 10 according to the present exemplary embodiment includes the main body portion 22, the rear portion 22B of the main body portion 22 being disposed further along (in proximity to) the inner face of the outer lens 14 at the rear side than the protruding portion 15, and the intermediate portion 22C of the main body portion 22 being separated from the inner face of the protruding portion 15 toward the vehicle width direction inner side, and includes the outer-side extending portion 24 that is integral with and branches from the rear portion 22B of the main body portion 22 and is disposed along (in proximity to) the inner face of the protruding portion 15.

This enables the rear side of the protruding portion 15 of the outer lens 14 not to appear dark due to the outer-side extending portion 24 when the door mirror 10 is viewed from the outside during non-lighting, thereby enabling spoiling of the appearance of the door mirror 10 to be suppressed. Further, during lighting, the light guiding reflecting surface of the light guiding lens 20 does not change.

The lens steps 28 are formed at an outer face of the light guiding lens 20 (the outer-side extending portion 24) that is adjacent to and faces the inner face of the outer lens 14. This enables the appearance through the outer lens 14 to be improved (enabling a high degree of freedom in appearance to be realized) when the door mirror 10 is viewed from the outside during non-lighting.

Further, in the light guiding lens 20, the connecting portion 26 is integral with and connects the front end portion of the outer-side extending portion 24 with the main body portion 22. This enables the rigidity of the light guiding lens 20 to be improved compared to a case in which the front end portion of the outer-side extending portion 24 with the main body portion 22 are not integral with and connected together by the connecting portion 26.

The light guiding lens 20 enables the cover 16 to be maintained in a state in which the cover 16 is disposed at the vehicle width direction outer side of the light source 18, such that light emission of the LED is not directly viewed from the outside, and there is no problem during lighting of glare when the LED is turned on. Namely, there is no decrease in the merchantability of the door mirror 10 with a side turn lamp.

Further, it can also be said that, the light guiding lens 20 has a hollow portion S formed in a substantially right-angled triangle shape in plan view at the vehicle width direction inner side of the protruding portion 15. This enables the amount of the resin material that is used for molding the light guiding lens 20 to be reduced, and enables the cooling time (manufacturing time) during molding to be reduced, compared to a case in which the hollow portion S is not formed (see FIG. 6B).

Namely, the light guiding lens 20 enables manufacturing costs, mass, and emission amount of carbon dioxide during manufacturing to be reduced. In addition, since the outer-side extending portion 24 and the connecting portion 26 of the light guiding lens 20 are each formed with a thickness that is thinner than the thickness of the main body portion 22, there is less need to add a resin material for molding the light guiding lens 20. Therefore, the present exemplary embodiment enables the door mirror 10 with a side turn lamp, which is excellent in appearance during non-lighting and lighting, to be manufactured at low cost.

### Modified Examples and Reference Examples

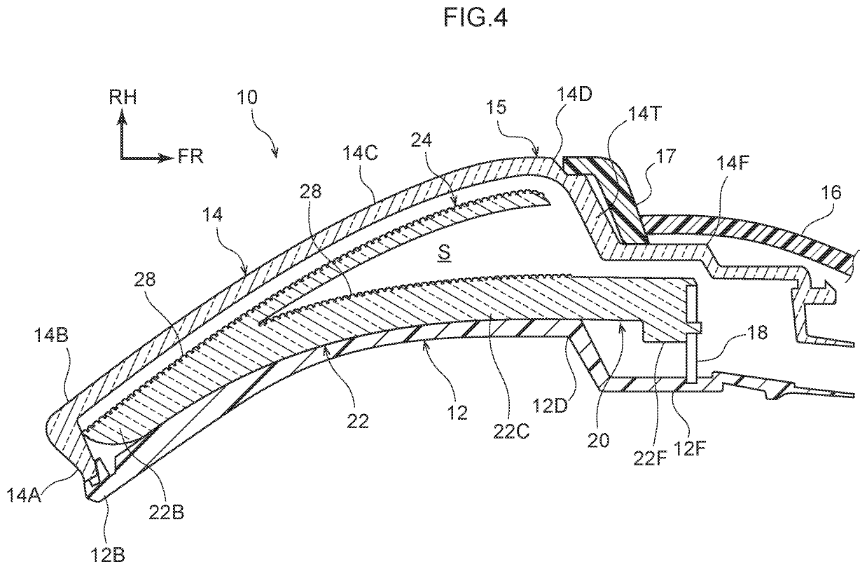

Note that as illustrated in FIG. 4, the light guiding lens 20 may be configured such that the connecting portion 26 is not formed, as long as the light guiding lens 20 has a size and shape that secure the rigidity of the outer-side extending portion 24 (modified example). Further, the light guiding lens 20 having such a configuration can be applied to, for example, a daytime running lamp (DRL) or a position lamp in the headlamp 30 (reference example).

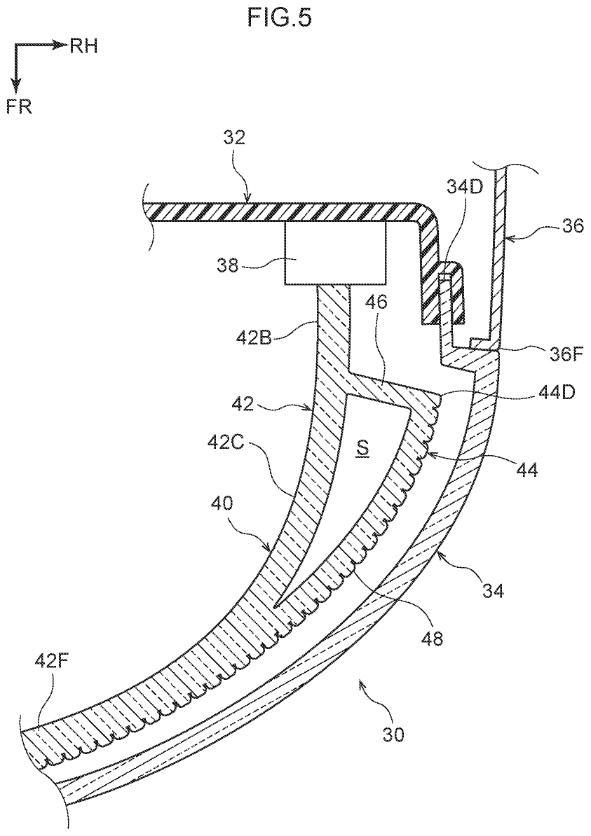

Specifically, as illustrated in FIG. 5, a housing 32 is provided at a vehicle width direction inner side of a fender 36, and a rear end portion 34D of an outer lens 34 is attached to a vehicle width direction outer side end portion of the housing 32. The rear end portion 34D of the outer lens 34 is disposed at a vehicle width direction inner side of a front end portion 36F of the fender 36, and the outer lens 34 extends toward the front side in a substantially arc shape in plan view from the front end portion 36F of the fender 36. Namely, an outer face of the outer lens 34 is flush with an outer face of the fender 36, and the configuration is such that no protruding portion is formed.

A light source 38 is attached to a front face of the housing 32, and a light guiding lens 40, which is equivalent to the above-described light guiding lens 20, is disposed at a front side of the light source 38 and an inner side the outer lens 34. Namely, the light guiding lens 40 also includes a main body portion 42, a front portion 42F of the main body portion 42 being disposed further along an inner face of the outer lens 34, and an intermediate portion 42C of the main body portion 42 being significantly separated from the inner face of the outer lens 34 toward the vehicle width direction inner side, and includes an outer-side extending portion 44 that is integral with and branches (branches) from the front portion 42F of the main body portion 42 and that is disposed along the inner face of the outer lens 34.

Namely, the light guiding lens 40 faces (is in proximity to) the inner face of the outer lens 34 with a small gap in the substantially vehicle width direction from an outer face of the front portion 42F of the main body portion 42 to an outer face of the outer-side extending portion 44, and the intermediate portion 42C of the main body portion 42 extends so as to be gradually separated from the outer lens 34 as it moves toward the rear side from the front portion 42F of the main body portion 42.

A rear portion 42B of the main body portion 42, which is integral with and continuous from an intermediate portion 42C of the main body portion 42, extends toward the rear side and is disposed at a vehicle width direction inner side of the rear end portion 34D of the outer lens 34 (a vehicle width direction outer side end portion of the housing 32), and the light source 38 is disposed at a rear face of the rear portion 42B. Further, a connecting portion 46 is integral with and connects a rear end portion 44D of the outer-side extending portion 44 and the intermediate portion 42C of the main body portion 42.

Therefore, a configuration is such that, a hollow portion S having a substantially right-angled triangular shape in plan view, with the right-angled portion positioned at the vehicle width direction outer side, is formed at the light guiding lens 40. Further, lens steps 48 serving as a pattern are formed from the outer face of the front portion 42F of the main body portion 42 to the outer face of the outer-side extending portion 44. Therefore, the same operation and advantageous effects as described above can also be obtained with respect to the DRL and the position lamp in the headlamp 30 including the light guiding lens 40 configured in this manner.

Although the door mirror 10 (vehicle outer mirror) according to the present exemplary embodiments has been explained above based on the drawings, the door mirror 10 (vehicle outer mirror) according to the present exemplary embodiments is not limited to those illustrated in the drawings, and the design can be appropriately modified within a range not departing from the gist of the present disclosure.

For example, the shape of the hollow portion S is not limited to the substantially right-angled triangle shape illustrated in the drawings. Namely, the shapes (lengths, angles, and the like), in plan view, of the main body portion 22, the outer-side extending portion 24, and the connecting portion 26 of the light guiding lens 20 may be appropriately modified according to the design of the door mirror 10. In addition, the configuration may be such that the lens steps 28 are not formed at the outer face of the intermediate portion 22C facing the hollow portion S of the main body portion 22.

What is claimed is:

1. A vehicle outer mirror, comprising:
an outer lens that includes a protruding portion, the protruding portion protruding out further toward a vehicle width direction outer side, at a vehicle rear side, than a cover that covers a vehicle width direction outer side of a light source; and
a light guiding lens that includes a main body portion, a rear portion of the main body portion being disposed further along an inner face of the outer lens, at the vehicle rear side, than the protruding portion, and an intermediate portion of the main body portion being separated from an inner face of the protruding portion toward a vehicle width direction inner side, and that includes an outer-side extending portion that is integral with and branches from the rear portion of the main body portion and that is disposed along the inner face of the protruding portion, the light guiding lens guiding light from the light source.

2. The vehicle outer mirror according to claim 1, wherein a pattern is formed at an outer face of the outer-side extending portion.

3. The vehicle outer mirror according to claim 1, further comprising a connecting portion that is integral with and connects a front end portion of the outer-side extending portion with the main body portion.

4. A vehicle outer mirror, comprising:
an outer lens that includes a protruding portion, the protruding portion protruding out further toward a vehicle width direction outer side, at a vehicle rear side, than a cover that covers a vehicle width direction outer side of a light source; and
a light guiding lens that is made of resin, that is disposed along an inner face of the outer lens, and that guides light from the light source,
wherein the light guiding lens includes a hollow portion that is formed at a vehicle width direction inner side of the protruding portion, and that has a substantially right-angled triangle shape in plan view.

5. The vehicle outer mirror according to claim 4, wherein a pattern is formed at an outer face of the light guiding lens which faces the inner face of the outer lens.
